(19) United States
(12) Patent Application Publication
(10) Pub. No.: US 2021/0094214 A1
(43) Pub. Date: Apr. 1, 2021

(54) CONTROL DEVICE AND CONTROL METHOD FOR INJECTION MOLDING MACHINE

(71) Applicant: FANUC CORPORATION, Minamitsuru-gun (JP)

(72) Inventor: Atsushi Horiuchi, Yamanashi-ken (JP)

(21) Appl. No.: 17/036,539

(22) Filed: Sep. 29, 2020

(30) Foreign Application Priority Data
Sep. 30, 2019 (JP) 2019-179254

(51) Int. Cl. B29C 45/77; B29C 45/47

(52) U.S. Cl. CPC B29C 45/77; B29C 45/47; B29C 2945/76066; B29C 2945/76859; B29C 2945/76187; B29C 2945/76498; B29C 2945/76665; B29C 2945/76381

(57) ABSTRACT

A control device for an injection molding machine includes a pressure acquisition unit that acquires a resin pressure, a measurement unit that measures an elapsed time period or a rotation amount of the screw from when the screw has reached a predetermined metering position, a reverse rotation control unit that causes the screw to be rotated in reverse from when the screw has reached the predetermined metering position, and a condition determination unit that determines the reverse rotation time period based on a required time period from when the screw has reached the predetermined metering position until when the resin pressure falls to a target pressure, or determines the reverse rotation amount based on a required reverse rotation amount from when the screw has reached the predetermined metering position until when the resin pressure falls to the target pressure.

### CROSS-REFERENCE TO RELATED APPLICATION

This application is based upon and claims the benefit of priority from Japanese Patent Application No. 2019-179254 filed on Sep. 30, 2019, the contents of which are incorporated herein by reference.

### BACKGROUND OF THE INVENTION

### Field of the Invention

The present invention relates to a control device and a control method for an injection molding machine.

### Description of the Related Art

In relation to an injection molding machine, several methods have been proposed in order to reduce variations in the product quality of molded products. For example, in Japanese Laid-Open Patent Publication No. 09-029794, in relation to an injection device (injection unit), it has been proposed to perform sucking back of a screw, and reverse rotation of the screw sequentially after metering of a resin. According to the disclosure, and in accordance with such actions, variations in weight of the resin inside the cylinder are reduced.

### SUMMARY OF THE INVENTION

The step of carrying out sucking back and reverse rotation of the screw after metering is also referred to as a pressure reducing process (pressure reducing step). In carrying out reverse rotation of the screw in such a pressure reducing process, it is necessary to determine in advance a duration (reverse rotation time period) of the reverse rotation or an amount of rotation (reverse rotation amount) of the reverse rotation.

Up until now, the operator has obtained the reverse rotation time period or the reverse rotation amount by repeatedly performing trial and error attempts. Such operations tend to be troublesome for the operator to perform. Further, for an operator who is particularly unfamiliar with handling an injection molding machine, since the operator may not be able to appropriately determine the reverse rotation time period or the reverse rotation amount, molding defects are disadvantageously made to occur.

Thus, the present invention has the object of providing a control device and a control method for an injection molding machine, in which, in a pressure reducing process, a reverse rotation time period or a reverse rotation amount can appropriately and easily be determined.

One aspect of the present invention is a control device for an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the control device including a pressure acquisition unit configured to acquire a pressure of the resin, a measurement unit configured to measure an elapsed time period or an amount of rotation of the screw from when the screw has reached the predetermined metering position, a reverse rotation control unit configured to reduce the pressure of the resin by causing the screw to be rotated in reverse based on a reverse rotation time period that was determined beforehand or a reverse rotation amount that was determined beforehand from when the screw has reached the predetermined metering position, and also configured to, in a case that the reverse rotation time period or the reverse rotation amount is not determined, cause the screw to be rotated in reverse from when the screw has reached the predetermined metering position, in order to determine the reverse rotation time period or the reverse rotation amount, and a condition determination unit configured to, in the case that the reverse rotation time period is not determined, determine the reverse rotation time period based on a required time period from when the screw has reached the predetermined metering position until when the pressure of the resin falls to a predetermined target pressure, or configured to, in the case that the reverse rotation amount is not determined, determine the reverse rotation amount based on a required reverse rotation amount from when the screw has reached the predetermined metering position until when the pressure of the resin falls to the target pressure.

Another aspect of the present invention is a method of controlling an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the method including a reverse rotation step of reducing a pressure of the resin by causing the screw to be rotated in reverse based on a reverse rotation time period that was determined beforehand or a reverse rotation amount that was determined beforehand from when the screw has reached the predetermined metering position, and in a case that the reverse rotation time period or the reverse rotation amount is not determined, causing the screw to be rotated in reverse based on a predetermined reverse rotational speed or a predetermined reverse rotational acceleration while measuring the pressure of the resin and an elapsed time period or an amount of rotation of the screw, from when the screw has reached the predetermined metering position, and a condition determining step of, in the case that the reverse rotation time period is not determined, determining the reverse rotation time period based on a required time period from when the screw has reached the predetermined metering position until when the pressure of the resin falls to a predetermined target pressure, or in the case that the reverse rotation amount is not determined, determining the reverse rotation amount based on a required reverse rotation amount from when the screw has reached the predetermined metering position until when the pressure of the resin falls to the target pressure.

According to the present invention, a control device and a control method for an injection molding machine are provided, in which, in a pressure reducing process, a reverse rotation time period or a reverse rotation amount can appropriately and easily be determined.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a side view showing an injection molding machine according to an embodiment of the present invention;

FIG. 2 is a schematic cross-sectional view of an injection unit;

FIG. 3 is a schematic configuration diagram of a control device;

FIG. 4 is a flowchart showing an example of a control method for the injection molding machine according to the embodiment;

FIG. 5 shows time charts (when a reverse rotation time period is not specified) of a rotational speed (of a screw), a rearward movement speed (of a screw), and resin pressure (inside a cylinder) in the case that the control method of FIG. 4 is performed;

FIG. 6 shows time charts (when a reverse rotation time period is specified) of a rotational speed (of a screw), a rearward movement speed (of a screw), and a resin pressure (inside a cylinder) in the case that the control method of FIG. 4 is performed; and

FIG. 7 is a schematic configuration diagram of a control device according to a first modification.

### DESCRIPTION OF THE PREFERRED EMBODIMENTS

Preferred embodiments of a control device and a control method for an injection molding machine according to the present invention will be presented and described in detail below with reference to the accompanying drawings. Moreover, it should be noted that the directions described below conform to the respective arrows shown in each of the drawings.

### EMBODIMENTS

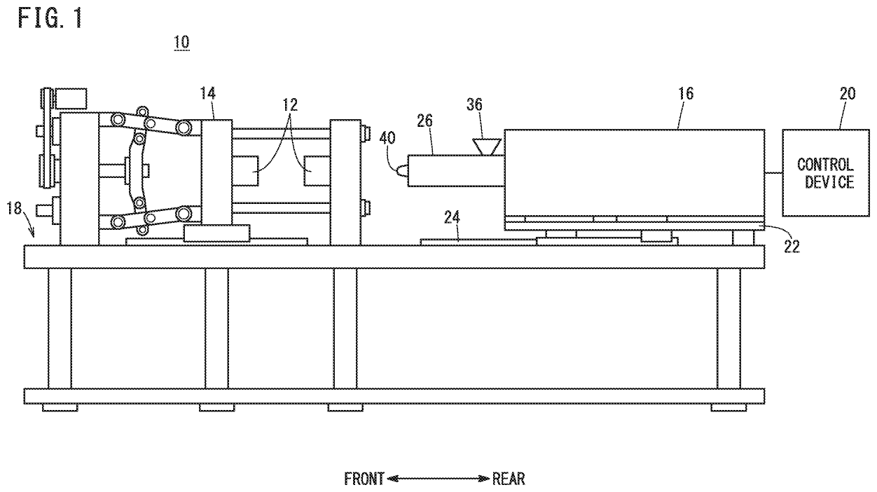

FIG. 1 is a side view of an injection molding machine 10 according to an embodiment of the present invention.

The injection molding machine 10 according to the present embodiment comprises a mold clamping unit 14 having a mold 12 that is capable of being opened and closed, an injection unit 16 that faces toward the mold clamping unit 14 in a front-rear direction, a machine base 18 on which such components are supported, and a control device 20 that controls the injection unit 16.

Among such components, the mold clamping unit 14 and the machine base 18 can be configured based on a known technique. Accordingly, in the following discussion, descriptions of the mold clamping unit 14 and the machine base 18 will be appropriately omitted.

Prior to describing the control device 20 of the present embodiment, at first, a description will be given concerning the injection unit 16, which is a control target of the control device 20.

The injection unit 16 is supported by a base 22, and the base 22 is supported by a guide rail 24 which is installed on the machine base 18 so that the base 22 is capable of moving forward and backward. Consequently, the injection unit 16 is capable of moving forward and backward on the machine base 18, and can both come into contact with and separate away from the mold clamping unit 14.

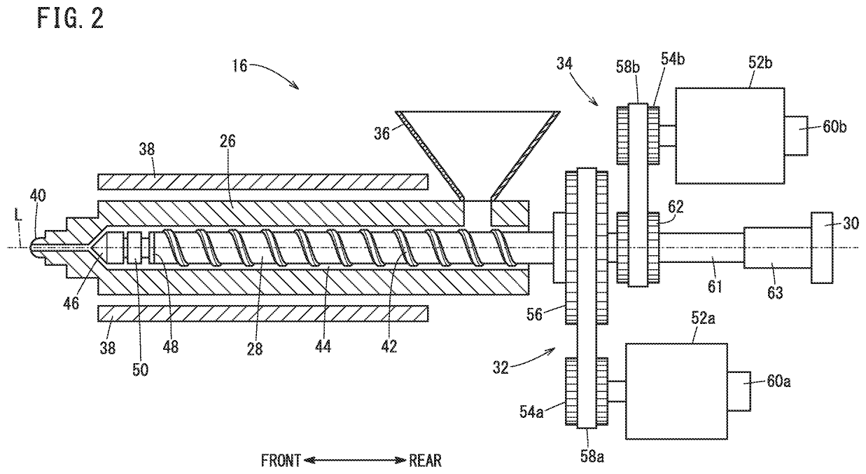

FIG. 2 is a schematic cross-sectional view of the injection unit 16.

The injection unit 16 is equipped with a tubular shaped heating cylinder (cylinder) 26, a screw 28 provided inside the cylinder 26, a pressure sensor 30 provided on the screw 28, and a first drive device 32 and a second drive device 34 connected to the screw 28.

The axial lines of the cylinder 26 and the screw 28 coincide with each other on an imaginary line L according to the present embodiment. Such a system may also be referred to as an “in-line (in-line screw) system”. Further, the injection molding machine to which the in-line system is applied may also be referred to as an “in-line injection molding machine”.

As advantages of such an in-line injection molding machine, there may be cited, for example, a point in which the structure of the injection unit 16 is simpler, and a point in which the maintainability thereof is excellent, as compared with other types of injection molding machines. In this instance, as another type of injection molding machine, for example, a preplasticating type injection molding machine is known.

As shown in FIG. 2, the cylinder 26 includes a hopper 36 provided on a rear side, a heater 38 for heating the cylinder 26, and a nozzle 40 provided on a front-side end thereof. Among such elements, the hopper 36 is provided with a supply port for supplying a molding material resin to the cylinder 26. Further, an injection port for injecting the resin into the cylinder 26 is provided on the nozzle 40. The screw 28 includes a spiral flight part 42 provided to span across the longitudinal (front-rear) direction thereof. The flight part 42, together with an inner wall of the cylinder 26, constitutes a spiral flow path 44. The spiral flow path 44 guides in a frontward direction the resin that is supplied from the hopper 36 into the cylinder 26.

The screw 28 includes a screw head 46 which is on a distal end on the front side, a check seat 48 that is disposed at a certain distance in a rearward direction from the screw head 46, and a check ring (a ring for backflow-prevention) 50 that is capable of moving between the screw head 46 and the check seat 48.

The check ring 50 moves in a frontward direction relative to the screw 28 when the check ring receives a forward pressure from the resin located on a rear side of the check ring 50 itself. Further, upon receiving a rearward pressure from the resin on the front side thereof, the check ring 50 moves in a rearward direction relative to the screw 28.

At a time of metering (to be described later), the resin which is supplied from the hopper 36 to the supply port of the cylinder 26 is fed and compressed in the frontward direction while being melted along the flow path 44 by the forward rotation of the screw 28, and the pressure on a more rearward side than the check ring 50 becomes larger. When this occurs, the check ring 50 moves in the frontward direction, and the flow path 44 is gradually opened accompanying such movement. Consequently, the resin becomes capable of flowing toward the front side beyond the check seat 48 along the flow path 44.

Conversely, at a time of injection, the pressure on the front side becomes greater than the pressure on the rear side of the check ring 50. When this occurs, the check ring 50 moves in the rearward direction relative to the screw 28, and the flow path 44 is gradually closed accompanying such movement. When the check ring 50 is moved rearward until being seated on the check seat 48, a state is brought about in which it is maximally difficult for the resin to flow forward and rearward of the check ring 50, and a situation is prevented in which the resin on a more frontward side than the check seat 48 flows in reverse to a more rearward side than the check seat 48.

The pressure sensor 30, such as a load cell or the like for sequentially detecting the pressure imposed on the resin inside the cylinder 26, is attached to the screw 28. According to the present embodiment, the above-described “pressure imposed on the resin inside the cylinder 26” is also referred to simply as a “pressure of the resin” or alternatively a “resin pressure”.

The first drive device 32 serves to rotate the screw 28 inside the cylinder 26. The first drive device 32 includes a servomotor 52a, a drive pulley 54a, a driven pulley 56, and a belt member 58a. The drive pulley 54a rotates integrally with a rotary shaft of the servomotor 52a. The driven pulley 56 is disposed integrally on the screw 28. The belt member 58a transmits the rotational force of the servomotor 52a from the drive pulley 54a to the driven pulley 56.

When the rotary shaft of the servomotor 52a rotates, the rotational force of the servomotor 52a is transmitted to the screw 28 via the drive pulley 54a, the belt member 58a, and the driven pulley 56. Consequently, the screw 28 rotates.

In this manner, by causing the rotary shaft of the servomotor 52a to rotate, the first drive device 32 serves to rotate the screw 28. Moreover, by changing the direction in which the rotary shaft of the servomotor 52a is rotated, in response to the changing, the direction of rotation of the screw 28 can be switched between forward rotation and reverse rotation.

A position/speed sensor 60a is provided on the servomotor 52a. The position/speed sensor 60a detects the rotational position and the rotational speed of the rotary shaft of the servomotor 52a. The detection result therefrom is output to the control device 20. Consequently, the control device 20 is capable of calculating the rotation amount, the rotational acceleration, and the rotational speed of the screw 28, based on the rotational position and the rotational speed detected by the position/speed sensor 60a.

The second drive device 34 serves to move the screw 28 forward and rearward (which may be also referred to as “backward” in this specification) inside the cylinder 26. The second drive device 34 includes a servomotor 52b, a drive pulley 54b, a belt member 58b, a ball screw 61, a driven pulley 62, and a nut 63. The drive pulley 54b rotates integrally with a rotary shaft of the servomotor 52b. The belt member 58b transmits the rotational force of the servomotor 52b from the drive pulley 54b to the driven pulley 62. An axial line of the ball screw 61 and an axial line of the screw 28 coincide with each other on the imaginary line L. The nut 63 is screw-engaged with the ball screw 61.

When a rotational force is transmitted from the belt member 58b, the ball screw 61 converts the rotational force into linear motion, and transmits the linear motion to the screw 28. Consequently, the screw 28 is moved forward and rearward.

In this manner, by causing the rotary shaft of the servomotor 52b to rotate, the second drive device 34 serves to move the screw 28 forward and rearward. Moreover, by changing the direction in which the rotary shaft of the servomotor 52b is rotated, in response to the changing, the movement direction of the screw 28 can be switched between forward movement (advancing) and rearward movement (retracting).

Further, a position/speed sensor 60b which is similar to the position/speed sensor 60a is provided on the servomotor 52b. As the position/speed sensor 60b, there may be used the same type of sensor as the position/speed sensor 60a described above, however the present invention is not limited to this feature. Consequently, the control device 20 is capable of calculating the forward and rearward positions of the screw 28 in the front-rear direction, as well as the rearward movement speed (forward and rearward movement speeds) of the screw 28, based on the rotational position and rotational speed detected by the position/speed sensor 60b.

In the above-described injection unit 16, when the resin is introduced into the cylinder 26 through the hopper 36 and the screw 28 is forwardly rotated, the resin is gradually fed and compressed in the frontward direction along the flow path 44.

During such a time, the resin is melted (plasticized) by being subjected to heating by the heater 38 and due to the rotational force of the screw 28. The molten resin accumulates in a region on the front side of the check seat 48 inside the cylinder 26. Hereinafter, the region on the front side of the check seat 48 inside the cylinder 26 is also referred to as a “metering region”.

The forward rotation of the screw 28 is initiated from a state in which the screw 28 has been fully advanced inside the cylinder 26 (a state in which the volume of the metering region is at a minimum), and is performed until the screw 28 has been moved rearward to a predetermined position (metering position). Further, the rearward movement of the screw 28 is performed so as to maintain the resin pressure in the vicinity of a predetermined value (metering pressure) P1. This series of steps is also referred to as a “metering (metering step)”.

By determining the position of the screw 28 at the metering position by moving the screw 28 rearward so as to maintain the resin pressure during metering in the vicinity of the metering pressure P1, it is possible to keep the volume of the metering region and the density of the resin substantially constant each time that the metering is performed.

However, inertia is generated in the servomotor 52a that causes the screw 28 to rotate, and the drive pulley 54a, the belt member 58a, and the driven pulley 56 that transmit the rotational force of the servomotor 52a. Accordingly, even if the rotation of the screw 28 is stopped, the screw 28 cannot be stopped instantaneously. For this reason, a time lag occurs during a period from when the screw 28 has reached the metering position and until the forward rotation of the screw 28 comes to a stop. During such a time lag as well, the resin is continuously fed and compressed from the rearward direction toward the frontward direction. Furthermore, also after the forward rotation of the screw 28 has been stopped, due to the influence of viscous resistance of the molten resin, the flow of the resin from the rearward direction toward the frontward direction is not stopped instantaneously, and the resin continues to be fed and compressed for a while.

Due to the above factors, the amount of resin accumulated in the metering region is actually greater than an amount (appropriate amount) of the resin required for satisfactory molding. If the amount of resin in the metering region is excessive, a molding defect may occur in which molten resin leaks from the tip of the nozzle 40. Such a molding defect is also referred to as drooling (leakage). Such drooling causes variations to occur in the masses of molded products that are mass-produced by the injection molding machine 10. Variation in the masses of the molded products is not preferable when attempting to mass-produce molded products having uniform product quality. Further, the resin that has leaked due to drooling may solidify. Such leaked resin that has solidified is also referred to as cold slag (cold slug). Cold slag leads to clogging of the nozzle 40. When the nozzle 40 gets clogged, injection of resin from the injection unit 16 is hindered. Therefore, the generation of cold slag is undesirable.

In order to prevent the aforementioned drooling and cold slag from occurring, after the screw 28 has reached the metering position, a “pressure reduction (pressure reducing step)” is executed by the injection unit 16. In the pressure reducing step, rotation (reverse rotation) of the screw 28 is carried out in a direction opposite to the direction of rotation at the time of metering. When the reverse rotation is performed, the resin inside the cylinder 26 moves along the flow path 44 from a side in the frontward direction (the nozzle 40) to a side in the rearward direction (the hopper 36). Movement of the resin inside the cylinder 26 from the frontward direction to the rearward direction is also referred to as backflowing.

By causing such backflowing, the resin inside the cylinder 26, which includes the resin in the metering region, is scraped toward the rearward side inside the cylinder 26 along the flow path 44. Consequently, the density of the resin inside the cylinder 26 decreases, and therefore, the resin pressure decreases. In addition, by the resin pressure being reduced, any concern over the occurrence of drooling can be reduced. Since the concern over the occurrence of drooling is reduced, any concern over generation of cold slag is also reduced.

In addition, when backflowing is made to occur, the amount of resin in the metering region decreases. Upon doing so, the amount of resin in the metering region that was excessive gets close to the appropriate amount. Accordingly, any concerns over the occurrence of drooling and cold slag can more suitably be reduced.

The pressure reducing step is preferably continued until the resin pressure becomes a target pressure P0. According to the present embodiment, the target pressure P0 is zero (atmospheric pressure). However, the target pressure P0 is not necessarily limited in this manner, and for example, may be a value in close proximity to zero.

The reverse rotation of the screw 28 is performed on the basis of reverse rotation conditions determined beforehand prior to execution thereof. The reverse rotation conditions are indicative of conditions related to reverse rotation. Typical conditions related to reverse rotation are the four items of a reverse rotation time period Trb, a reverse rotation amount Rrb, a reverse rotational speed Vrb, and a reverse rotational acceleration Arb.

Among these conditions, the reverse rotation time period Trb is an item that specifies a time period from when the screw 28 reaches the metering position until when the reverse rotation of the screw 28 is completed. The reverse rotation amount Rrb is an item that specifies the amount of rotation from when the screw 28 reaches the metering position until when the reverse rotation of the screw 28 is completed. The reverse rotation comes to an end when an elapsed time period from when the screw 28 reached the metering position has arrived at the reverse rotation time period Trb, or when an amount of rotation of the screw 28 from when the screw 28 reached the metering position has arrived at the reverse rotation amount Rrb.

By the reverse rotation conditions, either the reverse rotation time period Trb or the reverse rotation amount Rrb can be specified as a reverse rotation terminal condition. The operator can select which one of the reverse rotation time period Trb or the reverse rotation amount Rrb is to be specified by the reverse rotation conditions. The value of the selected reverse rotation time period Trb or the reverse rotation amount Rrb will be described in detail later, but according to the present embodiment, such a value is a value that is determined by the control device 20. Accordingly, in the present embodiment, there is no particular need for the operator to specify the value of the reverse rotation time period Trb or the reverse rotation amount Rrb.

Further, among the four typical items for the reverse rotation conditions, the reverse rotational speed Vrb is an item that specifies the maximum rotational speed of the screw 28 that rotates in reverse. In addition, the reverse rotational acceleration Arb is an item that specifies the maximum rotational acceleration of the screw 28 that rotates in reverse. The reverse rotational speed Vrb and the reverse rotational acceleration Arb impart an influence to the vigorousness (rapidity) of the decrease in the resin pressure when the reverse rotation is performed. The resin pressure drops vigorously (rapidly) as the reverse rotational speed Vrb and the reverse rotational acceleration Arb increase, and the resin pressure gently decreases as the reverse rotational speed Vrb and the reverse rotational acceleration Arb decrease.

The operator can specify both the value of the reverse rotational speed Vrb and the value of the reverse rotational acceleration Arb. In the case that the operator does not specify such values, default values determined by the manufacturer of the injection molding machine 10 at the design stage can be automatically specified.

After the metering step and the subsequent pressure reducing step, the resin accumulated in the metering region inside the cylinder 26 is filled into a cavity inside the mold 12. This process is also referred to as injection (injection step). In the injection step, the screw 28 is advanced on the side of the injection unit 16, while a mold clamping force is applied to the closed mold 12 on the side of the mold clamping unit 14. At this time, the mold 12 and the nozzle 40 are pressed into contact (placed in a nozzle touching) state. As a result, the molten resin is injected from the tip end of the nozzle 40 toward the cavity inside the mold 12. After having carried out the injection step, the mold clamping unit 14 performs a step that may be referred to as “mold opening (mold opening step)” to open the mold 12. Consequently, the resin that is filled in the cavity inside the mold 12 is taken out from the mold 12 as a molded product. Following the mold opening step, a step that may be referred to as “mold closing (mold closing step)” is performed in which the mold 12 included in the mold clamping unit 14 is closed in preparation for a subsequent molding.

The combination of the plurality of steps executed by the injection molding machine 10 in order to produce the molded product is also referred to as a “molding cycle”. Any of the aforementioned metering step, the pressure reducing step, the injection step, the mold opening step, and the mold closing step is a step that can be included in the molding cycle. By repeatedly executing the molding cycle, the injection molding machine 10 is capable of mass producing molded products.

In this instance, points that should be considered in order to perform high quality molding will be described. In the pressure reducing step, if the reverse rotation time period Trb or the reverse rotation amount Rrb is excessively small, the resin pressure does not reach the target pressure P0, even if the reverse rotation is carried out on the basis of the specified reverse rotation time Trb or the specified reverse rotation amount Rrb. In this case, the risk of the occurrence of drooling is not sufficiently reduced. Accordingly, as the reverse rotation time period Trb or the reverse rotation amount Rrb, it is desirable to specify a value that is sufficiently large, so that the pressure of the resin after completion of reverse rotation reaches the target pressure P0.

On the other hand, when the reverse rotation time period Trb or the reverse rotation amount Rrb is excessively large, then even if the resin pressure reaches the target pressure P0, the reverse rotation does not end. In this case, there is a concern that air may be drawn into the cylinder 26 from the nozzle 40, and air bubbles (foreign matter) may become mixed in the resin. Air bubbles that are mixed in the resin cause variations in the masses of the molded products. Further, the amount of resin in the metering region becomes insufficient due to excessive backflow. Accordingly, it is desirable that the reverse rotation time period Trb or the reverse rotation amount Rrb be appropriately set, in a manner so that the aforementioned entrainment of air does not take place, and so that excessive backflow does not occur.

However, in order to properly determine the reverse rotation time period Trb or the reverse rotation amount Rrb, an operator has generally been required to perform trial and error attempts taking into consideration the metering conditions and the material characteristics of the resin. Such operations tend to be troublesome for the operator to perform. Further, there is a concern that the reverse rotation time period Trb or the reverse rotation amount Rrb that is determined may vary depending on whether or not the operator is accustomed to handling the injection molding machine 10. Such variations lead to destabilization in the product quality of the molded products, as well as destabilization in the time required for the pressure reducing step, which in turn leads to destabilization in production efficiency when mass-producing molded products.

Thus, according to the present embodiment, the reverse rotation time period Trb or the reverse rotation amount Rrb is appropriately and easily determined by the control device 20, which will be described in detail below.

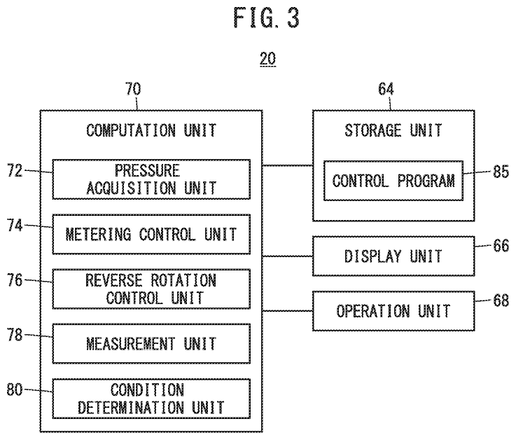

FIG. 3 is a schematic configuration diagram of the control device 20.

As illustrated in FIG. 3, the control device 20 is equipped with a storage unit 64, a display unit 66, an operation unit 68, and a computation unit 70 as a hardware configuration. The computation unit 70 may be configured by a processor such as a CPU (Central Processing Unit) or the like, however the present invention is not limited to this feature. The storage unit 64 includes a volatile memory and a nonvolatile memory, neither of which are shown. Examples of the volatile memory include a RAM or the like. Examples of the nonvolatile memory include a ROM, a flash memory, or the like.

A predetermined control program 85 for controlling the injection unit 16 is stored in advance in the storage unit 64, and apart therefrom, information is stored in the storage unit 64 as needed during execution of the control program 85. For example, the storage unit 64 stores the reverse rotation conditions.

The display unit 66, although not particularly limited, is a display device including, for example, a liquid crystal screen, and appropriately displays information in relation to the control process performed by the control device 20.

The operation unit 68, although not particularly limited, includes, for example, a keyboard, a mouse, or a touch panel that is attached to the screen of the display unit 66, and is used by an operator in order to transmit commands to the control device 20. The command transmitted by the operator to the control device 20, for example, is a command for specifying the target pressure P0, or a command for specifying the reverse rotation conditions.

As illustrated in FIG. 3, the computation unit 70 includes a pressure acquisition unit 72, a metering control unit 74, a reverse rotation control unit 76, a measurement unit 78, and a condition determination unit 80. These respective units are realized by the computation unit 70 executing the aforementioned control program 85 in cooperation with the storage unit 64.

The pressure acquisition unit 72 sequentially acquires the resin pressure detected by the pressure sensor 30. The acquired resin pressure is stored in the storage unit 64. At this time, the acquired resin pressure is stored in the storage unit 64, for example, in the form of time series data.

The metering control unit 74 performs the aforementioned metering step based on predetermined metering conditions (hereinafter, also simply referred to as “metering conditions”). A forward rotational speed (metering rotational speed) Vr of the screw 28 during metering, and the metering pressure P1 are defined as such metering conditions. The metering control unit 74 may refer to the metering conditions that are stored in advance in the storage unit 64, or may follow along with metering conditions that are instructed (specified) by the operator via the operation unit 68.

The metering control unit 74 controls the first drive device 32, and while causing the screw 28 to be forwardly rotated at the metering rotational speed Vr until the screw 28 arrives at the metering position, controls the second drive device 34 in a manner so that the resin pressure becomes the metering pressure P1, and thereby adjusts the rearward movement speed and the position of the screw 28. During this period, the metering control unit 74 performs the control while appropriately referring to the resin pressure acquired by the pressure acquisition unit 72, and the rotational speed acquired by the measurement unit 78.

The reverse rotation control unit 76 performs the above-described pressure reducing step by rotating the screw 28 in reverse after the screw 28 has reached the metering position. When the reverse rotation is performed, as has already been described, the pressure of the resin decreases, together with the amount of resin in the metering region approaching the appropriate amount.

The reverse rotation control unit 76 carries out the reverse rotation on the basis of the reverse rotation conditions. More specifically, the reverse rotation control unit 76 performs the reverse rotation after the screw 28 has reached the metering position, on the basis of a predetermined reverse rotational speed Vrb and a predetermined reverse rotational acceleration Arb specified by the reverse rotation conditions. The predetermined reverse rotational speed Vrb and the predetermined reverse rotational acceleration Arb may be default values specified by the manufacturer of the injection molding machine 10, or may be values specified by the operator via the operation unit 68. Further, if the reverse rotation time period Trb or the reverse rotation amount Rrb is specified by the reverse rotation conditions, then the timing at which the reverse rotation is ended is determined on the basis of such values. The measurement unit 78 carries out measurement of an elapsed time period or an amount of rotation of the screw 28 from when the screw 28 has reached the metering position.

In the case that the reverse rotation time period Trb or the reverse rotation amount Rrb is not specified by the reverse rotation conditions, the reverse rotation control unit 76 performs a necessary operation for determining such values. More specifically, in the case that the reverse rotation time period Trb or the reverse rotation amount Rrb is not specified, the reverse rotation control unit 76 initiates the reverse rotation based on the reverse rotation conditions after the screw 28 has reached the metering region. The reverse rotation conditions at this time specify at least one from among the predetermined reverse rotational speed Vrb and the predetermined reverse rotational acceleration Arb. Further, together therewith, the reverse rotation control unit 76 also invokes operation of the condition determination unit 80.

In the case that the reverse rotation time period Trb is not determined, the condition determination unit 80 determines the reverse rotation time period Trb based on a time period required from when the screw 28 has reached the metering position and until the resin pressure falls to the target pressure P0. Further, in the case that the reverse rotation amount Rrb is not determined, the condition determination unit 80 determines the reverse rotation amount Rrb based on a reverse rotation amount required from when the screw 28 has reached the metering position and until the resin pressure falls to the target pressure P0. Measurement of the required time period or the required reverse rotation amount is carried out by the measurement unit 78. In addition, the condition determination unit 80 stores the determined reverse rotation time period Trb or the determined reverse rotation amount Rrb in the storage unit 64 as one of the items specified by the reverse rotation conditions.

When the condition determination unit 80 determines the reverse rotation time period Trb or the reverse rotation amount Rrb, at that point, the reverse rotation control unit 76 ends the reverse rotation. Further, in the injection molding machine 10, when the condition determination unit 80 determines the reverse rotation time period Trb or the reverse rotation amount Rrb, at that point, the pressure reducing step is completed, and the molding cycle continues (the step following the pressure reducing step is initiated).

Upon starting of the pressure reducing step in the molding cycle, which is repeatedly performed thereafter, the reverse rotation control unit 76 carries out the reverse rotation on the basis of the reverse rotation conditions in which there are included the designations of the reverse rotation time period Trb or the reverse rotation amount Rrb determined by the condition determination unit 80.

The condition determination unit 80 determines the reverse rotation time period Trb or the reverse rotation amount Rrb, on the basis of the required reverse rotation amount or the required time period for the resin pressure to reach the target pressure P0, when the reverse rotation is carried out at the predetermined rotational speed and the predetermined rotational acceleration. Consequently, any concern over the reverse rotation time period Trb or the reverse rotation amount Rrb becoming excessively small or excessively large is reduced. Further, the need for the operator to perform trial and error attempts in order to determine an appropriate reverse rotation time period Trb or an appropriate reverse rotation amount Rrb is reduced.

When the reverse rotation time period Trb or the reverse rotation amount Rrb is determined, it is preferable that the condition determination unit 80 determines such values so as to be less than or equal to a predetermined upper limit value. In this instance, the upper limit value, for example, is a value specified beforehand by the operator via the operation unit 68. Consequently, the reverse rotation time period Trb or the reverse rotation amount Rrb is prevented from becoming excessively large, and any concern over air bubbles becoming mixed in the resin or the amount of resin in the metering region being insufficient is reduced.

An exemplary configuration of the control device 20 has been described above. Next, a description will be given concerning a method of controlling the injection molding machine 10. As a premise, it is assumed that the metering conditions have been specified in advance. Further, it is assumed that the reverse rotation time period Trb, the reverse rotational speed Vrb, and the reverse rotational acceleration Arb are included as items in the reverse rotation conditions. Furthermore, among the reverse rotation conditions, predetermined values are specified for the reverse rotational speed Vrb and the reverse rotational acceleration Arb, however, the reverse rotation time period Trb is not specified.

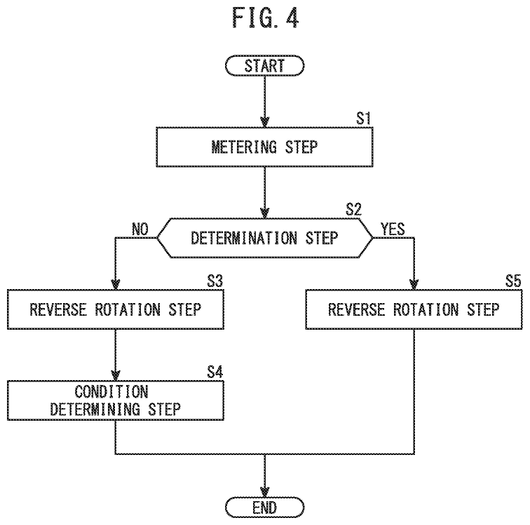

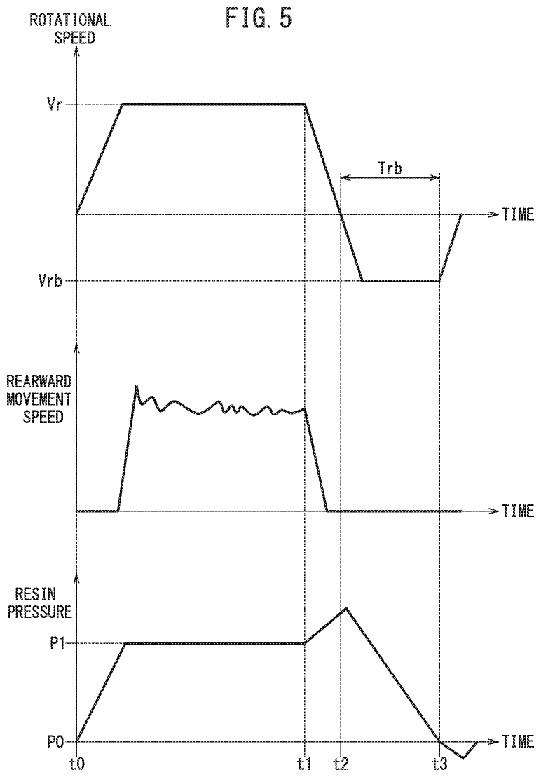

FIG. 4 is a flowchart showing an example of a control method for the injection molding machine 10 according to the present embodiment. FIG. 5 shows time charts (when the reverse rotation time period Trb is not specified) of a rotational speed (of the screw 28), a rearward movement speed (of the screw 28), and the resin pressure (inside the cylinder 26) in the case that the control method of FIG. 4 is performed.

In the three time charts in FIG. 5, the vertical axes represent the rotational speed, the rearward movement speed, and the resin pressure, in this order from the top of the drawing. Further, the horizontal axis in each of the time charts represents time.

Time t0 in FIG. 5 indicates a point in time when the metering step is started. Further, time t1 indicates a point in time at which the screw 28 arrives at the metering position. A time period from time t0 to time t1 is a time zone in which the metering step is carried out in the injection molding machine 10.

First, the control device 20 performs metering of the resin inside the cylinder 26 while melting the resin by moving the screw 28 rearward to the metering position while causing the screw 28 to forwardly rotate (step S1: metering step). The metering step is carried out on the basis of the metering conditions. The metering step continues until time t1 when the screw 28 reaches the metering position.

As shown in FIG. 5, the rotational speed of the screw 28 starts increasing from the start of the metering step at time t0, and thereafter, reaches a predetermined metering rotational speed Vr specified by the metering conditions. In addition, from the reaching until time t1, the rotational speed of the screw 28 is adjusted so as to maintain the metering rotational speed Vr. The direction of rotation of the screw 28 in the metering step is a forward rotation.

As shown in FIG. 5, the resin pressure starts increasing after time t0 accompanying the forward rotation of the screw 28, and thereafter, reaches the predetermined metering pressure P1 specified by the metering conditions. The rearward movement speed of the screw 28 starts to increase when the resin pressure comes in close proximity to the metering pressure P1, after the metering step has been started as shown in FIG. 5. Thereafter, until time t1, the rearward movement speed of the screw 28 is controlled in a manner so that the resin pressure is kept at the metering pressure P1.

Time t2 in FIG. 5 indicates a point in time when the reverse rotation is started. Further, time t3 indicates a point in time when the resin pressure reaches the target pressure P0. A time period from time t1 to time t3 is a time zone in which the pressure reducing step is carried out in the injection molding machine 10.

When the screw 28 reaches the metering position, by referring to the reverse rotation conditions, the reverse rotation control unit 76 determines whether or not the reverse rotation time period Trb or the reverse rotation amount Rrb, which is included as an item in the reverse rotation conditions, has been determined (step S2: determination step). Further, when the screw 28 reaches the metering position, the measurement unit 78 initiates measurement of the elapsed time period.

In the present example, as was described as a premise thereof, the reverse rotation time period Trb, which is included as an item in the reverse rotation conditions, is not specified. Due to this fact, the reverse rotation control unit 76 regards the determination result of the determination step to be “NO”.

In the case that the determination result of the determination step S2 is NO, the reverse rotation control unit 76 initiates the reverse rotation based on the predetermined reverse rotational speed Vrb and the predetermined reverse rotational acceleration Arb (step S3: reverse rotation step). Further, the reverse rotation control unit 76 invokes operation of the condition determination unit 80.

By starting the reverse rotation, the pressure of the resin decreases after t2. The fact that the rotational speed of the screw 28 is less than zero from time t2 to time t3 indicates that the screw 28 is rotating in reverse. The decreasing resin pressure reaches the target pressure P0 at time t3. When the resin pressure reaches the target pressure P0, the reverse rotation step (step S3) comes to an end.

Upon completion of the reverse rotation step S3, the condition determination unit 80 determines the reverse rotation time period Trb on the basis of the length of the time period (required time period) from time t2 to time t3 (step S4: condition determining step). As a result, the control method of the present embodiment comes to an end (END).

Thereafter, subsequent steps may be performed in accordance with the molding cycle. Further, when the determination step is performed subsequently by repeating the molding cycle, the condition determination unit 80 determines the reverse rotation time period Trb as described above, and therefore, the determination result is “YES”. In this case, the reverse rotation step (step S5) is performed.

In the reverse rotation step S5, in addition to the same predetermined reverse rotational speed Vrb and the same predetermined reverse rotational acceleration Arb as at the time of the reverse rotation step S3, the reverse rotation is performed on the basis of the reverse rotation time period Trb determined in the condition determining step.

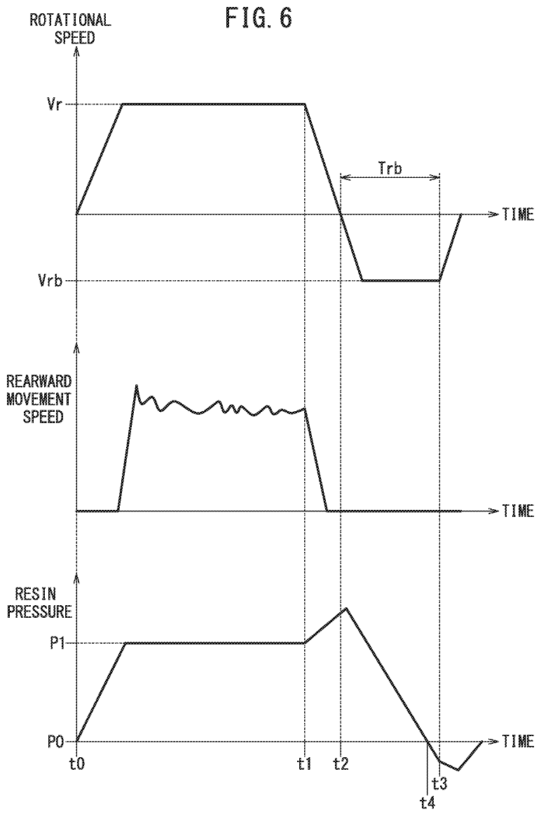

FIG. 6 shows time charts (when the reverse rotation time period Trb is specified) of the rotational speed (of the screw 28), the rearward movement speed (of the screw 28), and the resin pressure (inside the cylinder 26) in the case that the control method of FIG. 4 is performed.

In FIG. 6, temporal change of the rotational speed, the rearward movement speed, and the resin pressure in the case that the determination result of the determination step S2 is YES are shown. The point of difference between FIG. 6 and FIG. 5 is that, in FIG. 6, the resin pressure reaches the target pressure P0 at an earlier point in time (time t4) than time t3.

The resin possesses a viscosity as well as a fluidity. Accordingly, the resin pressure when the reverse rotation is carried out on the basis of the predetermined reverse rotational speed Vrb and the predetermined reverse rotational acceleration Arb decreases in a generally similar manner, but does not necessarily decrease in exactly the same way. This is the reason why the timing at which the resin pressure reaches the target pressure P0 differs between FIG. 5 (time t3) and FIG. 6 (time t4).

The size of the difference between time t3 and time t4, including whether such a difference occurs or not, differs for each molding cycle. Further, whether time t4 comes before or after time t3 differs for each molding cycle. This implies that the time required for the reduction in pressure varies depending on the molding cycle, and in the injection molding machine 10 in which the molding cycle is repeated several times, leads to destabilization in production efficiency.

When the reverse rotation time period Trb is specified, the reverse rotation control unit 76 continues the reverse rotation from time t2 and until the reverse rotation time period Trb has elapsed (time t3 is reached). More specifically, even if the resin pressure has reached the target pressure P0 as shown in FIG. 6, if the elapsed time period does not arrive at the reverse rotation time period Trb, the reverse rotation control unit 76 does not cause the reverse rotation to end. Further, if the elapsed time period has arrived at the reverse rotation time period Trb, the reverse rotation control unit 76 terminates the reverse rotation, even if the resin pressure does not reach the target pressure P0.

Consequently, in the case that the reverse rotation time period Trb is specified, time t3 is made uniform as the time at which the reverse rotation is ended. Accordingly, the time required for the pressure reducing step becomes stable.

In the above-described control method, in the case that the reverse rotation time period Trb is specified, cases may occur in which the reverse rotation comes to an end in a state in which the resin pressure does not coincide with the target pressure P0. However, if the resin material, the metering conditions, and the reverse rotation conditions remain unchanged, the resin pressure at the point in time when the reverse rotation ends lies in close proximity to the target pressure P0. Accordingly, even in the case of repeating the molding cycle to which the above-described control method is applied, the product quality of the molded products does not vary significantly, and it is possible to obtain molded products of stable quality.

In the foregoing manner, according to the control device 20 and the control method described above, the injection molding machine 10 is capable of mass-producing molded products with stable production efficiency and stable product quality. However, as will be exemplified below, it should be noted that the control device 20 and the control method of the present embodiment are not limited to the features described above.

As indicated above, in the control device 20, the metering and the reduction in pressure are carried out within the molding cycle. The process steps that the control device 20 is capable of controlling are not limited to the metering step and the pressure reducing step. For example, the control device 20 may also include constituent elements in order to control injection and mold closing.

The device or apparatus to which the control device 20 can be applied is not limited to an in-line injection molding machine (the injection molding machine 10). The control device 20 may be applied to a preplasticating type injection molding machine (a screw preplasticating type injection molding machine) which is equipped with a screw.

The configurations of the first drive device 32 and the second drive device 34 are not limited to the configurations described above. For example, instead of the servomotor 52a and the servomotor 52b, at least one of the first drive device 32 and the second drive device 34 may include a hydraulic cylinder or a hydraulic motor.

### [Modifications]

Although an embodiment has been described above as one example of the present invention, it goes without saying that various modifications or improvements are capable of being added to the above-described embodiment. It is clear from the scope of the claims that other modes to which such modifications or improvements have been added can be included within the technical scope of the present invention.

### (Modification 1)

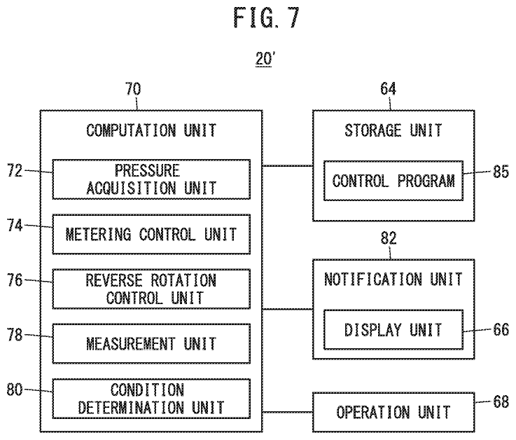

FIG. 7 is a schematic configuration diagram of the control device 20′ according to a first modification.

The control device 20 may further be equipped with a notification unit 82. According to the present modification, for purposes of convenience, the control device 20 that is further equipped with the notification unit 82 is also referred to as a control device 20′ in order to be distinguished from the control device 20 according to the embodiment. The notification unit 82, for example, issues a notification of the reverse rotation time period Trb or the reverse rotation amount Rrb determined by the condition determination unit 80. Consequently, the operator can be notified that the reverse rotation time period Trb or the reverse rotation amount Rrb has been determined. Alternatively, the notification unit 82 may issue a notification to such an effect in the case that the resin pressure does not lie within a predetermined range (in close proximity to the target pressure P0) at a point in time when the rotation of the screw is stopped on the basis of the reverse rotation time period Trb or the reverse rotation amount Rrb. Consequently, the operator can perceive beforehand by the notification from the control device 20′, that there is a risk that a molding defects could occur, and that there is a concern of a malfunction occurring in the injection molding machine 10.

The notification unit 82, although not particularly limited to such features, for example, is a speaker that emits sound, or a lamp (notification lamp) that emits light. The display unit 66 that was described in the embodiment may also serve as the notification unit 82. Alternatively, the notification unit 82 may be a combination of the above-described speaker, the lamp, and the display unit 66. The notification format in the case that the display unit 66 serves as the notification unit 82 may be, for example, a format in which predetermined icons or messages are displayed on a screen.

### (Modification 2)

The condition determination unit 80 may determine the reverse rotation time period Trb on the basis of a plurality of required time periods. Alternatively, the condition determination unit 80 may determine the reverse rotation amount Rrb on the basis of a plurality of required reverse rotation amounts. The plurality of required time periods are obtained by repeating the reverse rotation over a plurality of cycles based on the predetermined reverse rotational speed Vrb and the predetermined reverse rotational acceleration Arb. The same feature applies to the plurality of required reverse rotation amounts.

The condition determination unit 80 according to the present modification can determine, as the reverse rotation time period Trb, one of a minimum value, a maximum value, an average value, a median value, and a mode value of the plurality of required time periods. Further, the condition determination unit 80 according to the present modification can determine, as the reverse rotation amount Rrb, one of a minimum value, a maximum value, an average value, a median value, and a mode value of the plurality of required reverse rotation amounts.

Based on the plurality of required time periods, even if noise is included within such values, the influence of such noise on the reverse rotation time period Trb can be suppressed. Accordingly, the condition determination unit 80 according to the present modification is capable of determining the reverse rotation time period Trb with high reliability.

The same feature also applies to a case in which the reverse rotation amount Rrb is determined on the basis of the plurality of required reverse rotation amounts. The condition determination unit 80 according to the present modification is capable of determining the reverse rotation amount Rrb with high reliability on the basis of the plurality of required reverse rotation amounts.

In the present modification, which one of the minimum value, the maximum value, the average value, the median value, and the mode value of the plurality of required time periods (or the plurality of required reverse rotation amounts) is to be obtained as the reverse rotation time period Trb (or the reverse rotation amount Rrb) can be appropriately determined by the operator. Among such values, the most preferable is to obtain the mode value. The plurality of required time periods (or the plurality of required reverse rotation amounts) may exhibit variations due to the influence of environmental noise. By obtaining the mode value as the reverse rotation time period Trb (or the reverse rotation amount Rrb), it is possible to determine the reverse rotation time period Trb (or the reverse rotation amount Rrb) with higher reliability and in which the influence of environmental noise is reduced.

Further, in the present modification, at the time of determining the reverse rotation time period Trb on the basis of the plurality of required time periods, the condition determination unit 80 preferably determines the reverse rotation time period Trb based on required time periods obtained by excluding, from the plurality of required time periods, required time periods measured when the injection molding machine 10 is in a predetermined operating state. The same feature also applies to a case in which the reverse rotation amount is determined on the basis of the plurality of required reverse rotation amounts.

The predetermined operating state is a state in which molding is unstable. Such a state may correspond, for example, to a time immediately after operation of the injection molding machine 10 has started, to a time immediately after the production lot has been changed, or to a time when an abnormality occurs in peripheral equipment. In such cases, there is a concern that operation of the injection molding machine 10 may become unstable. By excluding required time periods and required reverse rotation amounts which are measured when the operation is in an unstable operating state, the reverse rotation time period Trb or the reverse rotation amount Rrb can be determined with higher reliability.

In relation to the matters discussed above, the control device 20 of the present modification may further be equipped with a monitoring unit that monitors and determines whether or not the injection molding machine 10 is in the predetermined operating state. Concerning the method by which the monitoring unit determines whether or not molding is proceeding in a stable manner, as listed below, several methods may be considered. For example, there is a method of making such a determination based on variations in the cycle time. The cycle time is defined as a time period required to complete the molding cycle one time. In this method, the monitoring unit measures the cycle time of the molding cycle each time that the molding cycle for which the required time (the required reverse rotational amount) should be measured is repeated. Further, each time that the molding cycle is completed one time, the monitoring unit calculates an average value of the plurality of cycle times that have been measured up to that point. In addition, concerning molding cycles in which cycle times with a large deviation from the average value are measured, the monitoring unit determines that they are molding cycles in which molding is not stable. The standard for judging whether or not the deviation is large is not limited, but whether or not the deviation is large can be determined, for example, by whether or not the cycle time exceeds the average value by ±10%. Measurement of the cycle time may be performed by the monitoring unit, or may be performed by the measurement unit 78. Moreover, it should be noted that the same determination need not necessarily be performed in units of the molding cycle, but the determination may be performed in units of a plurality of process steps included in the molding cycle.

### (Modification 3)

The above-described embodiments and the modifications thereof may be appropriately combined within a range in which no technical inconsistencies occur.

### INVENTIONS THAT CAN BE OBTAINED FROM THE EMBODIMENT

The inventions that can be grasped from the above-described embodiment and the modifications thereof will be described below.

### <First Invention>

The control device (20, 20′) for the injection molding machine (10) is provided. The injection molding machine includes the cylinder (26) into which the resin is supplied, and the screw (28) configured to move forward and rearward and rotate inside the cylinder (26). The injection molding machine performs metering of the resin while the resin is being melted inside the cylinder (26), by causing the screw (28) to be moved rearward to a predetermined metering position while being forwardly rotated. The control device includes the pressure acquisition unit (72) that acquires the pressure of the resin, the measurement unit (78) that measures the elapsed time period or the amount of rotation of the screw (28) from when the screw (28) has reached the predetermined metering position, the reverse rotation control unit (76) that reduces the resin pressure by causing the screw (28) to be rotated in reverse on the basis of the reverse rotation time period that was determined beforehand or the reverse rotation amount that was determined beforehand from when the screw (28) has reached the predetermined metering position, and that, in the case that the reverse rotation time period or the reverse rotation amount is not determined, causes the screw (28) to be rotated in reverse from when the screw (28) has reached the predetermined metering position, in order to determine the reverse rotation time period or the reverse rotation amount, and the condition determination unit (80) that, in the case that the reverse rotation time period is not determined, determines the reverse rotation time period based on the required time period from when the screw (28) has reached the predetermined metering position until when the resin pressure falls to the predetermined target pressure, or in the case that the reverse rotation amount is not determined, determines the reverse rotation amount based on the required reverse rotation amount from when the screw (28) has reached the predetermined metering position until when the resin pressure falls to the target pressure.

In accordance with such features, the control device (20, 20′) for the injection molding machine (10) is provided in which, in the pressure reducing step, the reverse rotation time period or the reverse rotation amount can appropriately and easily be determined.

The reverse rotation control unit (76) may cause the screw (28) to be rotated in reverse based on the predetermined reverse rotational speed or the predetermined reverse rotational acceleration, in both of a case in which the reverse rotation time period or the reverse rotation amount is determined, and a case in which the reverse rotation time period or the reverse rotation amount is not determined. In accordance with this feature, in the case that the reverse rotation is performed on the basis of the reverse rotation time period or the reverse rotation amount, the resin pressure lies within a vicinity of the target pressure.

The condition determination unit (80) may determine the reverse rotation time period or the reverse rotation amount in a manner so as to be less than or equal to a predetermined upper limit value. In accordance with this feature, the reverse rotation time period or the reverse rotation amount is prevented from becoming excessive.

There may further be provided the storage unit (64) that stores the required time period or the required reverse rotation amount, wherein, in the case that a plurality of the required time periods are stored in the storage unit (64), the condition determination unit (80) may determine, as the reverse rotation time period, one of a minimum value, a maximum value, an average value, a median value, and a mode value of the plurality of required time periods, or in the case that a plurality of the required reverse rotation amounts are stored in the storage unit (64), the condition determination unit may determine, as the reverse rotation amount, one of a minimum value, a maximum value, an average value, a median value, and a mode value of the plurality of required reverse rotation amounts. In accordance with such features, the reverse rotation time period or the reverse rotation amount is determined in which the influence of noise is suppressed.

The condition determination unit (80) may determine the reverse rotation time period based on required time periods obtained by excluding, from among the plurality of required time periods that are stored in the storage unit (64), required time periods measured when the injection molding machine (10) is in a predetermined operating state, or may determine the reverse rotation amount based on required reverse rotation amounts obtained by excluding, from among the plurality of required reverse rotation amounts that are stored in the storage unit (64), required reverse rotation amounts measured when the injection molding machine (10) is in the predetermined operating state. In accordance with such features, when the reverse rotation time period is obtained from among the plurality of required time periods, a more highly reliable reverse rotation time period is determined. Further, when the reverse rotation amount is obtained from among the plurality of required reverse rotation amounts, a more highly reliable reverse rotation amount is determined.

There may further be provided the operation unit (68) through which the operator specifies the target pressure, and the condition determination unit (80) may determine the reverse rotation time period or the reverse rotation amount on the basis of the target pressure specified through the operation unit (68).

There may further be provided the notification unit (82) that issues at least one of a notification of the reverse rotation time period or the reverse rotation amount determined by the condition determination unit (80), and a notification to such an effect in the case that the resin pressure does not reach the target pressure at a point in time when the reverse rotation of the screw (28) is stopped based on the reverse rotation time period or the reverse rotation amount. In accordance with this feature, the operator can be notified that the reverse rotation time period (Trb) or the reverse rotation amount (Rrb) has been determined. Further, the operator can perceive beforehand that there is a risk that a molding defect could occur, and that there is a concern of a malfunction occurring in the injection molding machine (10).

### <Second Invention>

The method of controlling the injection molding machine (10) is provided. The injection molding machine includes the cylinder (26) into which the resin is supplied, and the screw (28) configured to move forward and rearward and rotate inside the cylinder (26). The injection molding machine is configured to perform metering of the resin while the resin is being melted inside the cylinder (26), by causing the screw (28) to be moved rearward to a predetermined metering position while being forwardly rotated. The method includes the reverse rotation step of reducing the resin pressure by causing the screw (28) to be rotated in reverse on the basis of the reverse rotation time period that was determined beforehand or the reverse rotation amount that was determined beforehand from when the screw (28) has reached the predetermined metering position, and in the case that the reverse rotation time period or the reverse rotation amount is not determined, causing the screw (28) to be rotated in reverse based on a predetermined reverse rotational speed period or a predetermined reverse rotational acceleration while measuring the resin pressure and the elapsed time period or the amount of rotation of the screw (28), from when the screw (28) has reached the predetermined metering position, and the condition determining step of, in the case that the reverse rotation time period is not determined, determining the reverse rotation time period based on the required time period from when the screw (28) has reached the predetermined metering position until when the resin pressure falls to the predetermined target pressure, or in the case that the reverse rotation amount is not determined, determining the reverse rotation amount based on the required reverse rotation amount from when the screw (28) has reached the predetermined metering position until when the resin pressure falls to the target pressure.

In accordance with such features, the method of controlling the injection molding machine (10) is provided in which, in the pressure reducing step, the reverse rotation time period or the reverse rotation amount can appropriately and easily be determined.

What is claimed is:

1. A control device for an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the control device comprising:
a pressure acquisition unit configured to acquire a pressure of the resin;
a measurement unit configured to measure an elapsed time period or an amount of rotation of the screw from when the screw has reached the predetermined metering position;
a reverse rotation control unit configured to reduce the pressure of the resin by causing the screw to be rotated in reverse based on a reverse rotation time period that was determined beforehand or a reverse rotation amount that was determined beforehand from when the screw has reached the predetermined metering position, and also configured to, in a case that the reverse rotation time period or the reverse rotation amount is not determined, cause the screw to be rotated in reverse from when the screw has reached the predetermined metering position, in order to determine the reverse rotation time period or the reverse rotation amount; and
a condition determination unit configured to, in the case that the reverse rotation time period is not determined, determine the reverse rotation time period based on a required time period from when the screw has reached the predetermined metering position until when the pressure of the resin falls to a predetermined target pressure, or configure to, in the case that the reverse rotation amount is not determined, determine the reverse rotation amount based on a required reverse rotation amount from when the screw has reached the predetermined metering position until when the pressure of the resin falls to the target pressure.

2. The control device for the injection molding machine according to claim 1, wherein the reverse rotation control unit causes the screw to be rotated in reverse based on a predetermined reverse rotational speed or a predetermined reverse rotational acceleration, in both of a case in which the reverse rotation time period or the reverse rotation amount is determined, and a case in which the reverse rotation time period or the reverse rotation amount is not determined.

3. The control device for the injection molding machine according to claim 1, wherein the condition determination unit determines the reverse rotation time period or the reverse rotation amount in a manner so as to be less than or equal to a predetermined upper limit value.

4. The control device for the injection molding machine according to claim 1, further comprising:
a storage unit configured to store the required time period or the required reverse rotation amount;
wherein, in a case that a plurality of the required time periods are stored in the storage unit, the condition determination unit determines, as the reverse rotation time period, one of a minimum value, a maximum value, an average value, a median value, and a mode value of the plurality of required time periods, or in a case that a plurality of the required reverse rotation amounts are stored in the storage unit, the condition determination unit determines, as the reverse rotation amount, one of a minimum value, a maximum value, an average value, a median value, and a mode value of the plurality of required reverse rotation amounts.

5. The control device for the injection molding machine according to claim 4, wherein the condition determination unit determines the reverse rotation time period based on required time periods obtained by excluding, from among the plurality of required time periods that are stored in the storage unit, a required time period measured when the injection molding machine is in a predetermined operating state, or the condition determination unit determines the reverse rotation amount based on required reverse rotation amounts obtained by excluding, from among the plurality of required reverse rotation amounts that are stored in the storage unit, a required reverse rotation amount measured when the injection molding machine is in the predetermined operating state.

6. The control device for the injection molding machine according to claim 1, further comprising:
an operation unit through which an operator specifies the target pressure;
wherein the condition determination unit determines the reverse rotation time period or the reverse rotation amount based on the target pressure specified through the operation unit.

7. The control device for the injection molding machine according to claim 1, further comprising a notification unit configured to issue at least one of a notification of the reverse rotation time period or the reverse rotation amount determined by the condition determination unit, and a notification to an effect in a case that the pressure of the resin does not reach the target pressure at a point in time when reverse rotation of the screw is stopped based on the reverse rotation time period or the reverse rotation amount.

8. A method of controlling an injection molding machine, the injection molding machine including a cylinder into which a resin is supplied, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, the method comprising:
a reverse rotation step of reducing a pressure of the resin by causing the screw to be rotated in reverse based on a reverse rotation time period that was determined beforehand or a reverse rotation amount that was determined beforehand from when the screw has reached the predetermined metering position, and in a case that the reverse rotation time period or the reverse rotation amount is not determined, causing the screw to be rotated in reverse based on a predetermined reverse rotational speed or a predetermined reverse rotational acceleration while measuring the pressure of the resin and an elapsed time period or an amount of rotation of the screw, from when the screw has reached the predetermined metering position; and
a condition determining step of, in the case that the reverse rotation time period is not determined, determining the reverse rotation time period based on a required time period from when the screw has reached the predetermined metering position until when the pressure of the resin falls to a predetermined target pressure, or in the case that the reverse rotation amount is not determined, determining the reverse rotation amount based on a required reverse rotation amount from when the screw has reached the predetermined metering position until when the pressure of the resin falls to the target pressure.
